(19) United States
(12) Patent Application Publication
(10) Pub. No.: US 2015/0051932 A1
(43) Pub. Date: Feb. 19, 2015

(54) CONCURRENCY-BASED PROJECT MANAGEMENT SYSTEMS AND METHODS

(71) Applicant: FLUOR TECHNOLOGIES CORPORATION, Aliso Viejo, CA (US)

(72) Inventors: Robert Van Velzen, Driehuis (NL); Naresh Kaushik, Haarlem (NL)

(21) Appl. No.: 14/459,628

(22) Filed: Aug. 14, 2014

Related U.S. Application Data
(60) Provisional application No. 61/865,937, filed on Aug. 14, 2013.

(51) Int. Cl. G06Q 10/06

(52) U.S. Cl. CPC G06Q 10/06375; G06Q 10/063114; G06Q 10/0635
USPC 705/7.15

(57) ABSTRACT

A project management system is presented. The project management system leverages the concurrency of progress of at least two disciplines within a project as a performance metric with respect to management of the project. The concurrency of progress is defined as a degree to which two or more discipline's activities are concurrent with respect to completion. The project management system (1) produces a forecasted progress of multiple disciplines within a construction project based on the actual progress of the disciplines, (2) analyzes the concurrency between at least two disciplines based on the forecasted progress to identify any undesirable concurrency characteristics that may lead to a potential problem, and (3) generates a recommendation to change at least one attribute of the disciplines as a measure to avoid the undesirable concurrency characteristics.

This application claims priority to U.S. Application 61/865,937, filed Aug. 14, 2013. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is multi-discipline project management technologies.

### BACKGROUND

The following description includes information that may be useful in understanding the present invention. It is not an admission that any of the information provided herein is prior art or relevant to the presently claimed invention, or that any publication specifically or implicitly referenced is prior art.

Project management techniques have been employed for quite some time to ensure various types of projects are brought to completion efficiently and in a timely fashion. Capital construction projects represent one type of project that requires a great deal of project management attention because such projects span years, if not decades, and can cost billions of dollars. Thus, construction projects, especially in the Engineering, Procurement, and Construction (EPC) field, require solid project management metrics to ensure project activities are on track. Within EPC projects, many project disciplines (e.g., design, engineering, construction, process, piping, inspection, maintenance, etc.) must properly plan their activities so that their activities occur concurrently in an efficient manner, especially when one discipline's activities depend on another discipline's activities.

In the field of software engineering projects, some effort has been directed to managing large scale multi-dimensional projects in an efficient manner. U.S. Pat. No. 8,055,606 to Kreamer et al. titled “Method and System for Self-Calibrating Project Estimation Models for Packaged Software Application”, filed Jun. 13, 2007, describes an estimation system for implementing packaged software applications with self-calibration and refinement of project estimation models. Although useful for software, Kreamer fails to provide insight into resolving difficulties associated with managing concurrent multi-discipline activities within a project.

Additional effort has been directed to managing a facility through its lifecycle. U.S. patent application publication 2005/0267771 to Biondi et al. titled “Apparatus, System and Method for Integrated Lifecycle Management of a Facility”, filed May 27, 2004. Biondi describes a system that provides information about a facility so that historical information can be leveraged with respect to current projects. However, Biondi also lacks insight into managing project activities having concurrency requirements.

Within the EPC filed, co-owned U.S. patent application 2013/0197695 to Leitch et al. titled “Risk Assessment and Mitigation Planning, Systems and Methods”, filed Apr. 25, 2011, describes a risk assessment and planning system. Leitch describes many EPCCOM activities and efficacy attributes that can impact risk of large scale projects. Still, Leitch also fails to provide useful direction toward managing multi-discipline activities with respect to one or more concurrency requirements.

Interestingly, known efforts fail to appreciate that concurrency of project activities can provide a foundation for determining performance of various disciplines within a project. As described below in the Applicant's work, a concurrency metrics can indicate if at least two disciplines' activities proceed concurrently as planned relative to their actual execution.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for project management systems configured to generate one or concurrency metrics.

### SUMMARY OF THE INVENTION

The inventive subject matter provides apparatus, systems and methods in which a one can leverage concurrency as a performance metric with respect to project management, especially within capital construction projects. One aspect of the inventive subject matter includes a project management system comprising a project database and a project management engine. The project database is configured to store project progress data with respect to at least a first project discipline and a second project discipline. The progress data comprises a first set of progress data representing a progress of the first project discipline and a second set of progress data representing a progress of the second project discipline. The progress data for each discipline is indicative of the discipline's progress toward completion of project activities (e.g., tasks, projects, programs, etc.) with respect to time. For example, the project database can store progress data with respect to the process discipline, piping discipline, construction discipline, or other disciplines.

The project management system also includes a project management engine that is coupled with the project database. The project management engine is programmed to generate a first set of forecasted progress data from the first set of progress data, where the first set of forecasted progress data represents a prediction of future progress of the first project discipline. The project management engine is programmed to generate a second set of forecasted progress data from the second set of progress data, wherein the second set of forecasted data represents a prediction of future progress of the second project discipline. The project management engine is also programmed to derive a forecasted concurrency metric as a function of the first set of forecasted progress data and the second set of forecasted progress data. The forecasted concurrency metric represents temporal distances between different milestones along the progress of the first project discipline and corresponding milestones along the progress of the second project discipline. The project management engine is programmed to then analyze the forecasted concurrency metric to identify a potential defect in the project and generate a recommendation related to the progress of the two discipline to avoid the potential defect. Finally, the project management engine is programmed to configure an output device to present the recommendation.

In some embodiments, the project management system also includes several progress sensors that are programmed to monitor the actual progress of the first discipline and the actual progress of the second discipline. The progress sensors are also programmed to store information about the actual progress of the first and second disciplines as the first set of progress data and the second set of progress data in the project database.

The project management engine can analyze the forecasted concurrency metric in different ways. Under one approach, the project management engine can analyze the forecasted concurrency metric by comparing concurrency metric against benchmark concurrency metric. The benchmark concurrency metric comprises desirable temporal distance data for different milestones of the first and second project disciplines. In some embodiments, the project management engine is further programmed to analyze the concurrency metric by (i) obtaining, from the forecasted concurrency metric, a forecasted temporal distance between a first milestone of the first project discipline and a second milestone of the second project discipline, (ii) obtaining, from the benchmark concurrency metric, a benchmark temporal distance between a first milestone of the first project discipline and a second milestone of the second project discipline, (iii) comparing the forecasted temporal distance against the benchmark temporal distance, and (iv) identify the potential defect as a function of the difference between the forecasted temporal distance against the benchmark temporal distance.

The project management can generate different recommendations depending on the outcome of the forecasted concurrency metric analysis. For example, the project management engine can be programmed to generate a recommendation to speed up the progress of the first discipline when the forecasted temporal distance is less than the desirable temporal distance by a predetermined threshold. The project management engine can also be programmed to generate a recommendation to speed up the progress of the second discipline when the forecasted temporal distance is less than the desirable temporal distance by a predetermined threshold.

In some embodiments, the temporal distance indicates a period of time required after an end of a first task associated with the first project discipline and before a beginning of a second task associated with the second project discipline can occur.

The potential defect from having an undesirable concurrency in progress between two disciplines can include a quality defect, a cost defect, and/or a time delay defect.

In some embodiments, the first set of forecasted progress data comprises a first curve that indicates a forecasted progress of the first discipline over time, and the second set of forecasted progress data comprises a second curve that indicates a forecasted progress of the second discipline over time. In some of these embodiments, the project management engine is further programmed to derive the concurrency metric as a function of an integral over the first and second curves. In other words, the concurrency metric is derived as a function of an area between the first and second curves. The integral can be derived over a portion of the curves that covers a range of project completion, and not the entire curve. Preferably, the range is between 10% and 90% of the project completion. Even more preferably, the range is between 20% and 80% of the project completion.

In some embodiments, the project database further stores benchmark concurrency metric comprising a third curve that indicates a desirable progress of the first discipline over time, and a fourth curve that indicates a desirable progress of the second discipline over time. In some of these embodiments, the project management engine is further programmed to analyze the concurrency metric by computing a ratio of an area under the first and second curves with respect an area under the third and fourth curves.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates a schematic of a project management ecosystem of some embodiments.

FIG. 2A illustrates a graphical representation of the planned progresses of two disciplines.

FIG. 2B illustrates a graphical representation of the actual/forecasted progresses of two disciplines.

FIG. 3A illustrates a graphical representation of the planned progresses of two disciplines along with concurrency metrics.

FIG. 3B illustrates a graphical representation of the actual/forecasted progresses of two disciplines along with concurrency metrics.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network. One should appreciate that the disclosed content activation system provides many advantageous technical effects including facilitating user access to licensed content. The content activation system can identify an object within a digital representation. The content activation system can then identify a content activation policy and content associated with the identified object. For example, the system can provide a means for the user to purchase a licensing agreement to access content related to an object in a picture taken by the user. Further, the content activation system can then configure a device to activate or render the content for output.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the inventive subject matter are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventive subject matter are approximations, the numerical values set forth in the specific examples are reported as precisely as practicable. The numerical values presented in some embodiments of the inventive subject matter may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints and open-ended ranges should be interpreted to include only commercially practical values. The recitation of ranges of values herein is merely intended to serve as a shorthand method of referring individually to each separate value falling within the range. Unless otherwise indicated herein, each individual value within a range is incorporated into the specification as if it were individually recited herein. Similarly, all lists of values should be considered as inclusive of intermediate values unless the context indicates the contrary.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used in the description herein and throughout the claims that follow, when a system, engine, or a module is described as configured to perform a set of functions, the meaning of “configured to” is defined as one or more processors being programmed by a set of software instructions to perform the set of functions.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The inventive subject matter provides apparatus, systems and methods in which one can leverage the concurrency of progress of at least two disciplines within a project as a performance metric with respect to management of the project. The concurrency of progress is defined as a degree to which two or more discipline's activities are concurrent with respect to completion. In other words, two disciplines are highly concurrent when, at any given time throughout the progresses (e.g., percentages of completion) of the two disciplines, the progresses of the two disciplines are the same or very similar (e.g., within 10%, within 5% deviation from each other, etc.). By contrast, two disciplines are not concurrent when, at any given time throughout the progresses (e.g., percentages of completion) of the two disciplines, the progresses of the two disciplines are very different (e.g., more than 80%, more than 90% deviation from each other, etc.).

Complicated projects such as construction of a nuclear power plant usually involve multiple disciplinary areas. For example, a construction project can involve a planning discipline, a design discipline, an engineering discipline, a process discipline, a piping discipline, a maintenance discipline, an inspection discipline, a procurement discipline, a construction discipline, and a training discipline. Each of these disciplines can include tasks and sub-projects that contribute to the completion of the project.

Some of these tasks from one discipline are dependent on tasks from another discipline. For example, when a framing discipline finishes laying foundation on a site, it may require a period of time (e.g., several hours, several days, several weeks, etc.) for the foundation to set before a piping discipline to install the plumbing pipes for the site. Similarly, after a planning discipline has designed a plan for the site, it might require a period of time (e.g., several hours, several days, several weeks, etc.) for reviewing and verifying the feasibility of the design before a procurement discipline can begin purchasing parts for the plan. One can usually determine a desirable waiting time for each of the dependencies prior to the beginning of the construction project. The predetermined waiting times are determined based on an observation from past experience and/or from a priori knowledge that there might be potential defect within the project when the actual waiting time is shorter than the desirable waiting time (e.g., unstable concrete due to insufficient time for setting, last minute corrections in the plan which causes to increase costs due to insufficient time to review/verify feasibility of the plan, etc.) and that the project is being inefficient when the waiting time is longer than the desirable waiting time.

One can monitor the actual progress of the different disciplines and detects any undesirable progress concurrency between two or more disciplines of a project. However, by the time that the undesirable concurrency is detected, it might be impossible (or at least much more costly) to correct the problems. Thus, it is contemplated that the project management system of some embodiments (1) produces a forecasted progress of multiple disciplines within a construction project based on the actual progress of the disciplines, (2) analyzes the concurrency between at least two disciplines based on the forecasted progress to identify any undesirable concurrency characteristics that may lead to a potential problem, and (3) generates a recommendation to change at least one attribute of the disciplines as a measure to avoid the undesirable concurrency characteristics. The potential problem that may be caused by the undesirable concurrency characteristics includes a quality problem, a cost problem, and/or a time delay problem.

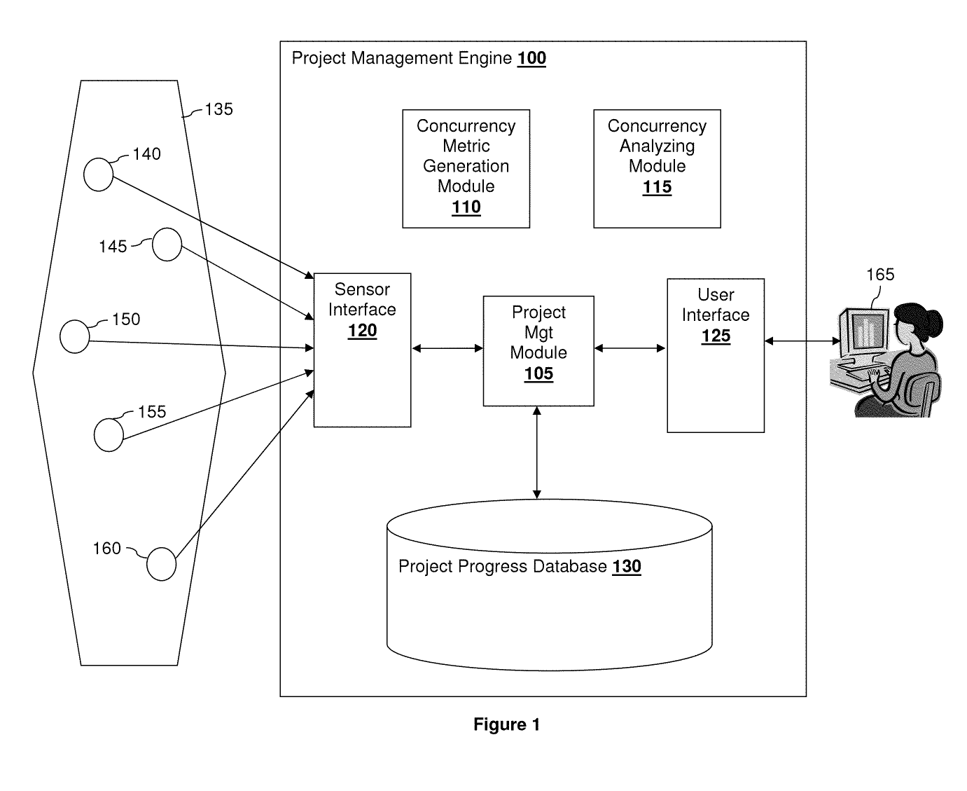

FIG. 1 illustrates an example project management engine 100 of some embodiments for managing a project in a construction site 135. The project management engine 100 includes a project management module 105, a concurrency metric generation module 110, a concurrency analyzing module 115, a sensor interface 120, and a user interface 125. In some embodiments, the project management module 105, the concurrency metric generation module 110, the concurrency analyzing module 115, the sensor interface 120, and the user interface 125 can be implemented as software instructions that when executed by one or more processing unit (e.g., a processor, a processing core, etc.) perform functionalities for the project management engine 100.

The project management engine 100 can include or communicatively coupled with a project progress database 130. The project progress database 130 comprises non-transitory permanent data storage such as a hard drive, a flash memory, etc., and can be implemented over one or more physical machines (e.g., across multiple hard drives, across multiple machines that are connected together via a network, etc.).

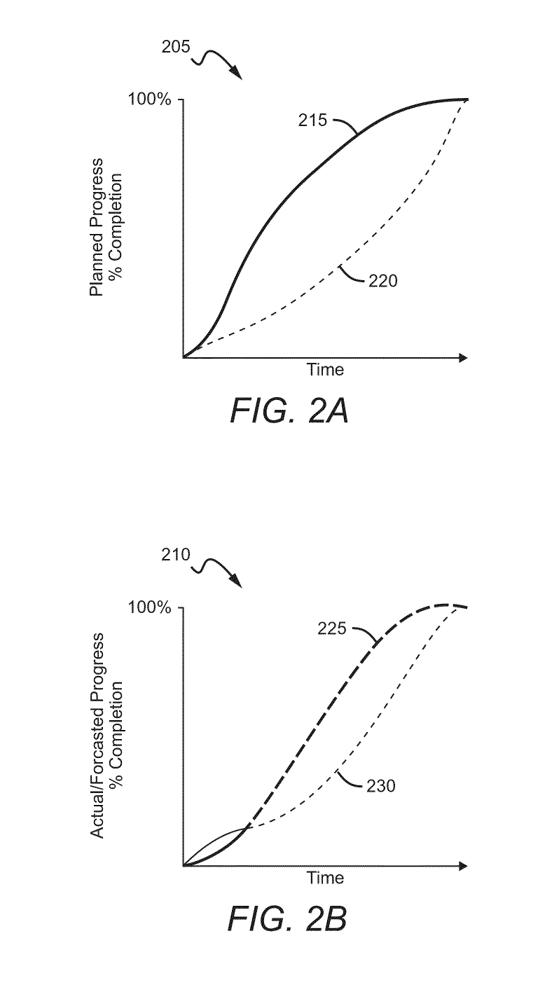

The project progress database 130 of some embodiments stores benchmark concurrency metrics for one or more projects. The benchmark concurrency metrics include information that represents the desirable concurrency between different pairs of disciplines for a project. FIG. 2A illustrates a graphical representation 205 of a desirable/planned concurrency between the progresses of two different disciplines. The graphical representation (or the graph) 205 has two axes: a time axis (the horizontal axis in this figure) that represents a time dimension and a progress axis (the vertical axis in this figure) that represents a progress (e.g., percentage of completion) for the disciplines. In some embodiments, the progress can be related to completion or fractional completion (e.g., 10% complete, 20% complete, etc.) of the corresponding discipline or project. The graph 205 shows the desirable concurrency of two disciplines (e.g., a process discipline and a piping discipline) by way of two curves 215 and 220 on the graph 205. Curve 215 is associated with one discipline (e.g., a process discipline) for the project and represents the desirable/planned progress for the discipline. Similarly, curve 220 is associated with the other discipline (e.g., a piping discipline) for the project and represents the desirable/planned progress for the discipline. As shown, although the process discipline and the piping discipline are shown to start at about the same time, the piping discipline is shown to lag behind the process discipline by a certain margin to achieve the desirable concurrency.

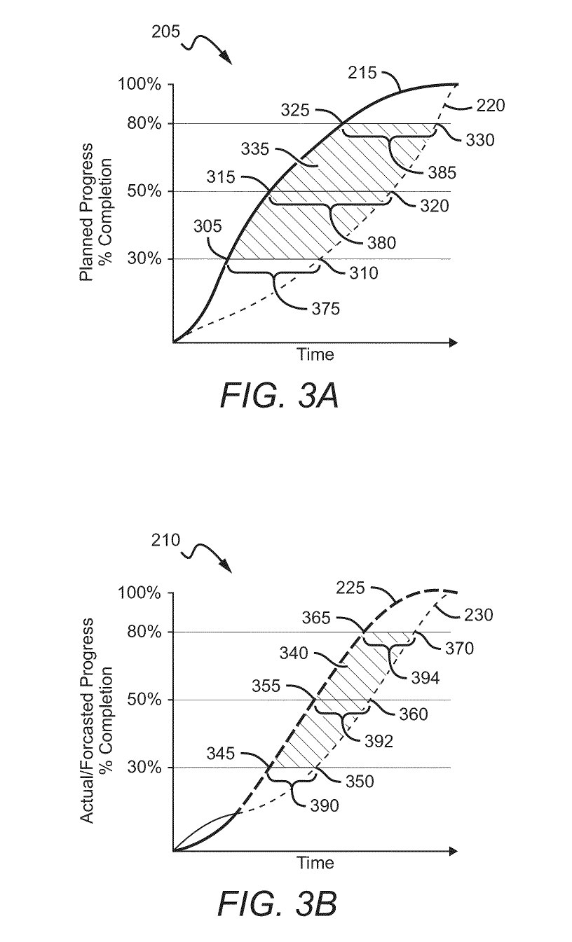

The benchmark concurrency metrics between two disciplines can be represented in many different ways. Under one approach, the benchmark concurrency metrics between two disciplines can be represented by the area between the two progress curves representing the two disciplines. As an example, FIG. 3A illustrates the same graphical representation 205 that includes a shaded area 335 between the curves 215 and 220. In some embodiments under this approach, the benchmark concurrency metrics can be represented by the shaded area 335 as illustrated in this figure. The area between the two curves 215 and 220 can be considered a measure of planned concurrency level between two disciplines. Thus, the area 335 between the curves 215 and 220 can be considered a concurrency metric. The area 335 can be calculated by following formula:

Area 335=∫_{20%}^{80%}[f(x)−g(x)]d(x)

where:

f(x)=Planned progress curve 215 for process discipline;

g(x)=Planned progress curve 220 for piping discipline; and

d(x)=change in % completion.

As shown, it is not necessary that the entire area between the curves 215 and 220 to be included in the benchmark concurrency metrics. The reasons can be that the beginning portion (the portion of the curves that are close to 0% completion) and the ending portion (the portion of the curves that are close to the 100% completion) might not provide as much guidance as to how the concurrency between the two disciplines should be. Therefore, it is preferable for the benchmark concurrency metrics to include only a portion of the area between the two curves (e.g., curve 215 and curve 220). Preferably, the benchmark concurrency metrics includes the areas between the portions of the two curves 215 and 220 from the 10% completion mark and the 90% completion mark. More preferably, the benchmark concurrency metrics includes the areas between the portions of the two curves 215 and 220 from the 20% completion mark to the 80% completion mark. The area (in square unit) can be used for comparison with the actual and/or forecasted concurrency metrics, which will be described in more detail below.

In many instances the two curves 215 and 220 are generated based partly on the waiting time requirements between the milestones from the process discipline and the corresponding milestones from the piping discipline. For example, based on historic data and a priori knowledge, it is determined that milestone 310 from the piping discipline should not occur until a period of time (e.g., time 375, which can be a minutes, hours, days, etc.) has passed after milestone 305 from the process discipline has occurred. Similarly, it is determined that milestone 320 from the piping discipline should not occur until a period of time (e.g., time 380, which can be a minutes, hours, days, etc.) has passed after milestone 315 from the process discipline has occurred, and that milestone 330 from the piping discipline should not occur until a period of time (e.g., time 385, which can be a minutes, hours, days, etc.) has passed after milestone 325 from the process discipline has occurred. Although only three concurrency requirements are shown in this figure, many more (or less) can be applied to the process discipline and the piping discipline.

Under another approach, instead of the area between the two curves, the benchmark concurrency metrics can be represented by the individual waiting time requirements between the pairs of corresponding milestones of the respective disciplines. For example, the benchmark concurrency metrics can be represented by the time 375 for the associated milestones 305 and 310, the time 380 for the associated milestones 315 and 320, and the time 385 for the associated milestones 325 and 330. The times 375, 380, and 385 and their associated milestones can be used for comparison with the actual and/or forecasted concurrency metrics, which will be described in more detail below.

Referring back to FIG. 1, the project management engine 100 includes a sensor interface 120 that is configured to retrieve sensor data from sensors 140-160 that are disposed at different places of the construction site 135. Examples of these sensors include video/still cameras, RFID readers, audio sensors, and others. The sensor data collected from these sensors 150-160 provides information that indicates the actual progress for each discipline. For example, each discipline includes multiple milestones where a task is about to begin or end. The sensor information in some embodiments can indicate whether a milestone has occurred for a discipline (e.g., whether a task has begun or has finished).

The sensor interface 120 is programmed to periodically pull/retrieve sensor information from these sensors 150-160 and pass the sensor information to the project management module 105. The project management module 105 can use the sensor information to construct an actual progress for each of the discipline. In addition to sensor information, the project management module 105 can receive user input with respect to the actual progress of the disciplines, via a personal computer 165 and the user interface 125. Based on the actual progress data, the project management module 105 of some embodiments can use the concurrency metric generation module 110 to forecast/predict a forecasted progress timeline for the disciplines.

FIG. 2B illustrates a graphical representation 210 of the actual and forecasted progresses for the process and piping disciplines. The graph 210 is similar to graph 205 where the horizontal axis represents time and the vertical axis represents the actual and forecasted progress (e.g., percentage of completion), except that the curves 225 and 230 represent the actual and forecasted progress of the process and piping disciplines, respectively on the graph 210. As shown, the solid line for each curve represents the actual progress (derived from the sensor data and user input) and the dotted line on the curve represents the forecasted progress generated by the project management module 105.

In some embodiments, the concurrency metric generation module 110 generates the forecasted progress for each discipline by using historic progress data and/or a priori knowledge. For example, the project management module 105 can accumulate historic progress data related to a discipline from past projects, compare the actual progress of the discipline in the current project with the historic progress data, and derive a forecasted progress for the discipline based on the comparison.

The concurrency metric generation module 110 then derives an actual/forecasted concurrency metrics for the two disciplines (e.g., the process discipline and the piping discipline) based on the actual/forecasted progress data for the two disciplines. FIG. 3B illustrates the graph 210 with additional concurrency indications. As shown in FIG. 3B, the graph 210 includes a shaded area 340 that represents the area between a portion of the two curves 225 and 230. Preferably, the area 340 represents the area between the two curves 225 and 230 from the 10% completion mark and the 90% completion mark. More preferably, the area 340 represents the area between the two curves 225 and 230 from the 10% completion mark and the 90% completion mark. The area 340 can be calculated using the following formula:

Area 340=∫_{20%}^{80%}[f′(x)−g′(x)]d(x)

where:

f′(x)=Actual progress curve for process engineering;

g′(x)=Actual progress curve for piping engineering; and

d(x)=change in % completion.

In addition, FIG. 3B also illustrates different forecasted times between pairs of corresponding milestones. In this example, the pair of milestones 345 and 350 are identical to milestones 305 and 310 of FIG. 3A, the pair of milestones 355 and 360 are identical to milestones 315 and 320 of FIG. 3A, and the pair of milestones 365 and 370 are identical to milestones 325 and 330 of FIG. 3A so that they can be compared against each other.

In this example, the figure illustrates that, according to the current forecast/prediction, milestone 350 of the piping discipline will not occur until a time 390 has passed by after milestone 345 of process discipline has occurred. Similarly, the figure also illustrates that milestone 360 of the piping discipline will not occur until a time 392 has passed by after milestone 355 of process discipline has occurred, and that milestone 370 of the piping discipline will not occur until a time 394 has passed by after milestone 365 of process discipline has occurred.

Similar to the benchmark concurrency metrics, the concurrency metric generation module 110 can generate the actual/forecasted concurrency metrics to include information about the shaded area 340, or the different forecasted wait times 390, 392, and 394 for their associated pairs of milestones. After generating the actual/forecasted concurrency metrics, the project management module 105 sends both the benchmark concurrency metrics and the actual/forecasted concurrency metrics to the concurrency analyzing module 115 for analysis.

Depending on how the concurrency metrics are represented, the concurrency analyzing module uses different methods to analyze the actual/concurrency metrics. When the actual/forecasted concurrency metrics are represented by the area between the curves associated with the two disciplines, the concurrency analyzing module 115 compares the area between the curves from the benchmark concurrency metrics and the area between the curves from the actual/forecasted concurrency metrics. As an example, referring to the graphs 205 and 210 in FIGS. 3A and 3B, the concurrency analyzing module 115 can compare the area 340 (that represents the actual/forecasted concurrency metrics) against the area 335 (that represents the benchmark concurrency metrics).

The change in concurrency levels between the benchmark and actual/forecasted concurrency metrics can be calculated by a percentage change in the areas as follows:

$$Δ C = \frac{Area 340}{Area 335} - 1 ⇒ \frac{{\int }_{20 \%}^{80 \%} [ {f}^{′} ( x ) - {g}^{′} ( x ) ] d ( x )}{{\int }_{20 \%}^{80 \%} [ f ( x ) - g ( x ) ] d ( x )} - 1$$

where ΔC can be represented by a percentage.

If the forecasted concurrency area 340 is smaller or larger than the benchmark concurrency area 335 by a predetermined amount (e.g., by 10%, 20%, 50%, etc.), the concurrency analyzing module 115 would determine that the concurrency between the two disciplines is undesirable and generate an alert to a user via the user interface 125. In addition to the alert, the concurrency analyzing module 115 can provide recommendations on how to correct this defect. The forecasted area being substantially smaller than the benchmark area can indicate a potential problem (e.g., quality problem, cost problem, etc.) in the future. By contrast, the forecasted area being substantially larger than the benchmark area can indicate inefficiency.

For example, the concurrency analyzing module 115 can recommend that the process discipline speeds up and/or recommend that the piping discipline slows down when the actual/forecasted concurrency area 340 is smaller than the benchmark concurrency area 335 by the predetermined amount. The concurrency analyzing module 115 can recommend that the piping discipline speeds up and/or recommend that the process discipline slows down when the actual/forecasted concurrency area 340 is larger than the benchmark concurrency area 335 by the predetermined amount.

When the actual/forecasted concurrency metrics are represented by the forecasted waiting time between the curves associated with the two disciplines, the concurrency analyzing module 115 compares the waiting times indicated by the curves from the benchmark concurrency metrics and the waiting times indicated by the curves from the actual/forecasted concurrency metrics. As an example, referring to FIGS. 3A and 3B, the concurrency analyzing module 115 can compare the forecasted waiting time 390 against the benchmark waiting time 375, compare the forecasted waiting time 392 against the benchmark waiting time 380, and compare the forecasted waiting time 394 against the benchmark waiting time 385. Based on the comparisons, the concurrency analyzing module 115 can generate alert and recommendations as described above when necessary. For example, if any one of the forecasted waiting time is shorter than the corresponding benchmark waiting time by a pre-determined amount (e.g., by 10%, 20%, 50%, etc.), the concurrency analyzing module 115 can generate an alert and in some embodiments recommend the that the process discipline speeds up and/or recommend that the piping discipline slows down. Similarly, if any one of the forecasted waiting time is longer than the corresponding benchmark waiting time by a pre-determined amount (e.g., by 10%, 20%, 50%, etc.), the concurrency analyzing module 115 can generate an alert and in some embodiments recommend the that the piping discipline speeds up and/or recommend that the process discipline slows down.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A project management system comprising:
a project database storing project progress data with respect to a first project discipline and a second project discipline for a project, wherein the progress data comprises a first set of progress data representing a progress of the first project discipline and a second set of progress data representing a progress of the second project discipline; and
a project management engine coupled with the project database and programmed to:
generate, from the first set of progress data, a first set of forecasted progress data representing a prediction of future progress of the first project discipline;
generate, from the second set of progress data, a second set of forecasted progress data representing a prediction of future progress of the second project discipline;
derive a forecasted concurrency metric as a function of the first set of forecasted progress data and the second set of forecasted progress data, wherein the forecasted concurrency metric represents temporal distances between different milestones along the progress of the first project discipline and corresponding milestones along the progress of the second project discipline,
analyze the forecasted concurrency metric to identify a potential defect in the project,
generate a recommendation related to the progress of the two discipline to avoid the potential defect, and
configure an output device to present the recommendation.

2. The system of claim 1, further comprising a plurality of progress sensors programmed to (i) monitor the actual progress of the first discipline and the actual progress of the second discipline and (ii) store information about the actual progress of the first and second disciplines as the first set of progress data and the second set of progress data in the project database.

3. The system of claim 1, wherein the project management engine is further programmed to analyze the forecasted concurrency metric by comparing concurrency metric against benchmark concurrency metric.

4. The system of claim 3, wherein the benchmark concurrency metric comprises desirable temporal distance data for different milestones of the first and second project disciplines.

5. The system of claim 4, wherein the project management engine is further programmed to analyze the concurrency metric by:
obtaining, from the forecasted concurrency metric, a forecasted temporal distance between a first milestone of the first project discipline and a second milestone of the second project discipline;
obtaining, from the benchmark concurrency metric, a benchmark temporal distance between a first milestone of the first project discipline and a second milestone of the second project discipline;
comparing the forecasted temporal distance against the benchmark temporal distance; and
identify the potential defect as a function of the difference between the forecasted temporal distance against the benchmark temporal distance.

6. The system of claim of claim 5, wherein the project management engine is further programmed to generate a recommendation to speed up the progress of the first discipline when the forecasted temporal distance is less than the desirable temporal distance by a predetermined threshold.

7. The system of claim 5, wherein the project management engine is further programmed to generate a recommendation to speed up the progress of the second discipline when the forecasted temporal distance is less than the desirable temporal distance by a predetermined threshold.

8. The system of claim 1, wherein the temporal distance indicates a period of time required after an end of a first task associated with the first project discipline and before a beginning of a second task associated with the second project discipline can occur.

9. The system of claim 1, wherein the potential defect comprises a quality defect.

10. The system of claim 1, wherein the potential defect comprises a cost defect.

11. The system of claim 1, wherein the potential defect comprises a time delay defect.

12. The system of claim 1, wherein the first set of forecasted progress data comprises a first curve that indicates a forecasted progress of the first discipline over time, and the second set of forecasted progress data comprises a second curve that indicates a forecasted progress of the second discipline over time.

13. The system of claim 12, wherein the project management engine is further programmed to derive the concurrency metric as a function of an integral over the first and second curves.

14. The system of claim 13, wherein the integral is derived over a range of project completion.

15. The system of claim 14, wherein the range is at least from 10% to 90% of the project completion.

16. The system of claim 14, wherein the range is at least from 20% to 80% of the project completion.

17. The system of claim 13, wherein the concurrency metric is derived as a function of an area under the first and second curves.

18. The system of claim 12, wherein the project database further stores benchmark concurrency metric comprising a third curve that indicates a desirable progress of the first discipline over time, and a fourth curve that indicates a desirable progress of the second discipline over time.

19. The system of claim 18, wherein the project management engine is further programmed to analyze the concurrency metric by computing a ratio of an area under the first and second curves with respect an area under the third and fourth curves.

20. The system of claim 1, wherein at least one of the first and the second disciplines include at least one of the following disciplines: planning, design, engineering, process, piping, maintenance, inspection, procurement, construction, and training.
